(19) United States
(12) Patent Application Publication
(10) Pub. No.: US 2026/0235270 A1
(43) Pub. Date: Aug. 13, 2026

(54) LIGHTING DEVICE FOR A MOTOR VEHICLE, IN PARTICULAR A HEADLAMP FOR A MOTOR VEHICLE

(71) Applicant: HELLA GMBH & CO. KGAA, Lippstadt (DE)

(72) Inventors: Mathias Drüppel, Bad Wünnenberg (DE); Bernd Fischer, Altenbeken (DE); Julian Grote, Borchen (DE); Lukas Hiller, Lippstadt (DE); Marc Kaup, Paderborn (DE); Dirk Kliebisch, Paderborn (DE); Susanne Köhler, Lippstadt (DE); Christian Schmidt, Paderborn (DE); David Schulz, Dortmund (DE)

(21) Appl. No.: 19/537,910

(22) Filed: Feb. 12, 2026

(30) Foreign Application Priority Data
Feb. 13, 2025 (DE) 102025105341.3

(51) Int. Cl. F21S 41/143; F21S 41/151; F21S 41/153; F21S 41/255

(52) U.S. Cl. CPC F21S 41/143; F21S 41/151; F21S 41/153; F21S 41/255

(57) ABSTRACT

The present invention relates to a lighting device for a motor vehicle. The lighting device includes at least one first light source, at least one primary optics, and at least one secondary optics. The lighting device is configured such that the light emanating from the at least one first light source passes through the at least one primary optics and through the at least one secondary optics to generate at least a first portion of a main lighting function, and a second light source which has a plurality of semiconductor elements, each having a light-emitting surface. The light-emitting surfaces of the semiconductor elements are arranged in a matrix-like manner for the targeted generation of pixels of a light distribution of at least a second portion of a main lighting function, and a projection optics configured to project the light emanating from the second light source into the exterior of the motor vehicle, and a common exit surface for the light used to generate the at least one first portion of a main lighting function and for the light used to generate the at least one second portion of a main lighting function.

### CROSS-REFERENCE TO RELATED APPLICATIONS

This application claims the benefit of German Patent Application 10-2025-105-341.3, filed Feb. 13, 2025, the disclosure of which is incorporated by reference in its entirety.

### BACKGROUND OF THE INVENTION

The present invention relates to a lighting device for a motor vehicle, in particular a headlamp for a motor vehicle.

DE 10-2017-105-888 A1 discloses a light module for a headlamp of a motor vehicle and a headlamp with such a light module. The light module comprises a light emitting unit with a plurality of point-shaped light sources arranged in a matrix, and projection optics with at least one projection lens, which projects the light emitted by the light emitting unit as the resulting light distribution of the light module onto a roadway in front of the motor vehicle. The light emitting unit may be designed as a matrix LED module. By directly projecting the luminous surface of the matrix LED module onto the traffic area, the desired light distribution, such as glare-free high beam (ADB), can already be achieved without having to manipulate the light pattern using primary optics.

A further lighting device designed as a headlamp for a motor vehicle is known from DE 10-2021-122-953 B3. The lighting device described therein comprises a plurality of light sources, from which light is emanating during operation of the lighting device, collimating optics serving as primary optics having a plurality of collimating lenses, each having an entry surface and an exit surface, through which the light emanating from the light sources passes, and secondary optics having a plurality of arrays of cylindrical lenses, wherein the light emanating from the collimating optics passes through the arrays of cylindrical lenses. By means of the module disclosed in DE 10-2021-122-953 B3, different main lighting functions, such as a high beam, an apron portion of a low beam, and a range portion of a low beam, can be generated.

In the case of headlamps, it is currently desirable to realize concepts that fulfill a so-called one-eye design despite generating different main lighting functions. This means that the light from different main lighting functions exits from only one exit surface. If a matrix LED module is to be used in the headlamp to generate a glare-free high beam and a one-eye design is desired at the same time, this should only be possible with matrix LED modules that have only a few light-emitting diodes, in particular, significantly fewer than 48 light-emitting diodes. The number of matrix segments can be increased by using a plurality of separate main lighting modules. However, this means that a one-eye design can no longer be guaranteed.

### SUMMARY OF THE INVENTION

The problem underlying the present invention is to create a lighting device of the type mentioned at the outset, which can generate a plurality of different main lighting functions, has a one-eye design, and has a light source with a plurality of semiconductor elements arranged in a matrix.

This is achieved by a lighting device of the type mentioned at the outset having features of the current embodiments of the invention.

In one embodiment, the lighting device comprises: at least one first light source; at least one primary optics; at least one secondary optics, wherein the lighting device is configured such that the light emanating from the at least one first light source passes through the at least one primary optics and through the at least one secondary optics to generate at least a first portion of a main lighting function; a second light source, which has a plurality of semiconductor elements, each having a light-emitting surface, wherein the light-emitting surfaces of the semiconductor elements are arranged in a matrix-like manner for the targeted generation of pixels of a light distribution of at least a second portion of a main lighting function; a projection optics which is configured to project light emanating from the second light source into the exterior of the motor vehicle; and a common exit surface for the light used to generate the at least one first portion of a main lighting function and for the light used to generate the at least one second portion of a main lighting function.

In this context, the lighting device may comprise a decoupling optics, at which the common exit surface is formed for the light used to generate the at least one first portion of a main lighting function and for the light used to generate the at least one second portion of a main lighting function. This creates a lighting device that can generate a plurality of different main lighting functions, has a one-eye design, and has a light source with a plurality of semiconductor elements arranged in a matrix.

It may be provided that the semiconductor elements of the second light source are designed as light-emitting diodes and are configured to be controlled independently of one another to generate pixels of a light distribution, in particular, wherein the second light source is designed as a solid-state LED array, wherein the solid-state LED array has, for example, 48 light-emitting diodes or more than 48 light-emitting diodes. Despite this large number of light-emitting diodes, the lighting device has a one-eye design.

It is possible that the lighting device has a plurality of first light sources and that the at least one primary optics is designed as collimating optics with a plurality of collimating lenses, each of which has an entry surface and an exit surface, through which the light emanating from the light sources passes successively.

It may be provided that the at least one secondary optics has a first portion formed on a transparent substrate having an entry surface and an exit surface, wherein a structure is provided on the entry surface and/or on the exit surface of the substrate, which is configured to shape the light passing therethrough in the vertical direction when the lighting device is installed in the vehicle, in particular, wherein the substrate is configured to generate a horizontal cut-off line and/or a gradual vertical light distribution. In this context, the transparent substrate of the at least one secondary optics may have at least one array of irregularly shaped cylindrical lenses, in particular, wherein the entry surface of the substrate has a plurality of input facets of different sizes and wherein the exit surface of the substrate has a plurality of output facets of equal size. This type of design can effectively create a horizontal cut-off line and/or a gradual vertical light distribution.

It may also be provided that the at least one secondary optics has a second portion which is integrated into the decoupling optics, wherein the second portion of the at least one secondary optics is configured to expand the light passing therethrough in the horizontal direction when the lighting device is installed in the vehicle. In this context, the second portion of the at least one secondary optics may be designed as a strip-shaped structure arranged on the exit surface of the decoupling optics, in particular, wherein the strip-shaped structure is formed by cylindrical lenses which are arranged next to one another in the horizontal direction when the lighting device is installed in the vehicle, wherein the cylinder axes of the cylindrical lenses extend in the vertical direction when the lighting device is installed in the vehicle in order to expand the light passing through the strip-shaped structure in the horizontal direction. By integrating the second portion of the secondary optics into the decoupling optics, it is possible, in contrast to lighting devices from the prior art, to dispense with a second transparent substrate. In particular, this also allows the lighting device to be designed more compactly.

It is possible that the lighting device comprises at least two first light sources, two primary optics, and two secondary optics, wherein the lighting device is configured such that the light emanating from at least one of the first light sources passes through the first primary optics and through the first secondary optics, and such that the light emanating from at least one other of the first light sources passes through the second primary optics and through the second secondary optics. The strip-shaped structure of the second portion of the first secondary optics and the strip-shaped structure of the second portion of the second secondary optics may be spaced apart from one another on the exit surface of the decoupling optics.

It may be provided that the projection optics has a lens, in particular, a lens designed as a Fresnel lens or a convex lens, which is integrated into the decoupling optics. In this context, the lens of the projection optics integrated into the decoupling optics may be arranged on the exit surface of the decoupling optics between the strip-shaped structure of the second portion of the first secondary optics and the strip-shaped structure of the second portion of the second secondary optics. This ensures that the light used to generate the at least one first portion of a main lighting function and the light used to generate the at least one second portion of a main lighting function exit through the same decoupling optics. Furthermore, this design allows to arrange the portions of the lighting device used to generate the plurality of main lighting functions in a space-saving manner.

It is possible that the projection optics, in addition to the lens integrated into the decoupling optics, has at least one further lens serving as a projection lens. In order to make the lighting device even more compact, it may be provided that the at least one further lens serving as a projection lens is combined with the transparent substrate of the at least one secondary optics in a single component.

It may be provided that the first portion of a main lighting function generated by the at least one first light source, the at least one primary optics, and the at least one secondary optics is at least a portion of a low beam and/or a high beam, preferably an apron portion and/or a city-light portion of a low beam.

It may further be provided that the second portion of a main lighting function generated by the second light source and the projection optics is at least a portion of a low beam and/or a high beam, preferably a range portion of a low beam and/or an adaptive high beam. Thus, the second light source may, for example, also generate a portion of the horizontal cut-off line of the low beam, in particular, the region around the inflection point between the left and right rising portion of the cut-off line.

### BRIEF DESCRIPTION OF THE DRAWINGS

The invention is explained in more detail below with reference to the accompanying figures. In the figures:

FIG. 1 is a schematic side view of a first exemplary embodiment of a lighting device according to an embodiment of the invention, partially illustrated as an exploded view;

FIG. 2 is a perspective view of the lighting device according to FIG. 1, partially illustrated as an exploded view;

FIG. 3 is a schematic side view of a second exemplary embodiment of a lighting device according to an embodiment of the invention;

FIG. 4 is a perspective view of the lighting device according to FIG. 3;

FIG. 5 is a perspective view of a substrate of the secondary optics of the lighting device according to FIG. 3; and

FIG. 6 is a detail of the substrate according to FIG. 5.

In the figures, identical or functionally identical parts are indicated with the same reference signs.

### DETAILED DESCRIPTION OF THE CURRENT EMBODIMENTS

The lighting device shown in the figures comprises six first light sources 1, two primary optics 2, and two secondary optics 3, wherein the lighting device is configured such that the light emanating from three of the first light sources 1 passes through a first of the primary optics 2 and through a first of the secondary optics 3, and such that the light emanating from three further of the first light sources 1 passes through a second of the primary optics 2 and through a second of the secondary optics 3. The first light sources 1, the two primary optics 2, and the two secondary optics 3 are used to generate at least a first portion of a main lighting function.

The lighting device further comprises a second light source 4, which has a plurality of light-emitting diodes (LEDs), each with a light-emitting surface, wherein the light-emitting surfaces of the light-emitting diodes are arranged in a matrix-like manner for the targeted generation of pixels of a light distribution of at least one second portion of a main lighting function. The second light source 4 is designed as a solid-state LED array, wherein the solid-state LED array has, for example, 48 light-emitting diodes or more than 48 light-emitting diodes.

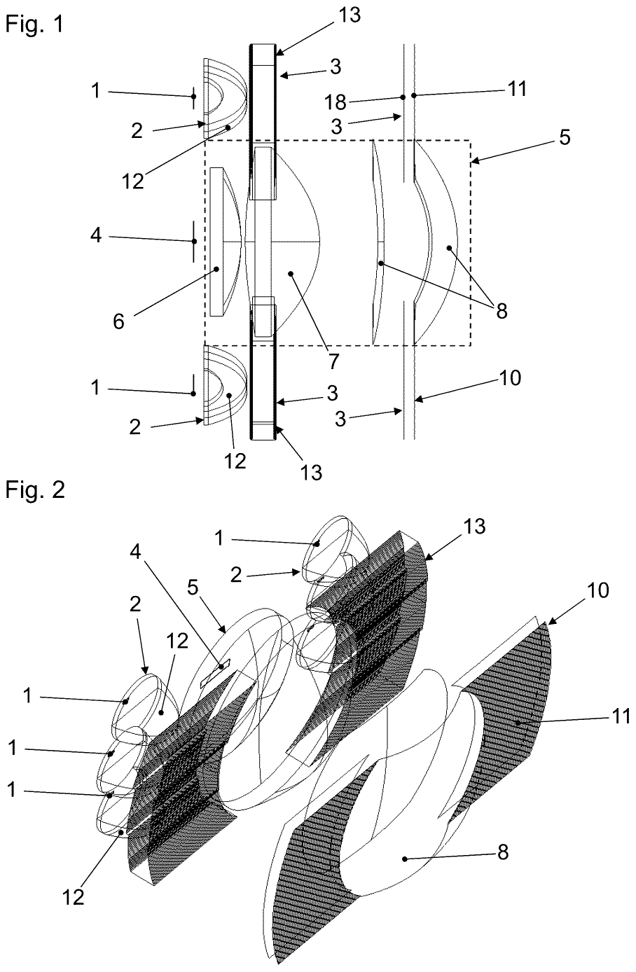

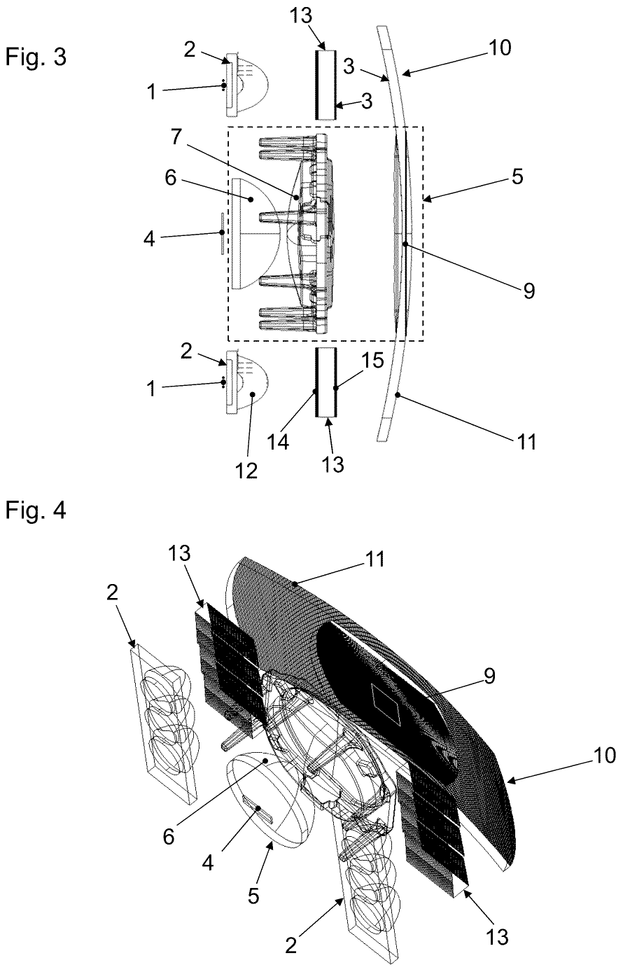

The lighting device also comprises a projection optics 5, which is configured to project light emanating from the second light source 4 into the exterior of the motor vehicle. In the first exemplary embodiment, the projection optics 5 has three convex lenses 6, 7, 8 (see FIG. 1). In the second exemplary embodiment, the third of the three convex lenses 6, 7, 8 is replaced by a lens 9 designed as a Fresnel lens (see FIG. 3).

The lighting device further comprises a decoupling optics 10, at which a common exit surface 11 is formed for the light used to generate the at least one first portion of a main lighting function and for the light used to generate the at least one second portion of a main lighting function.

In the illustrated exemplary embodiments, three first light sources 1 are arranged spaced apart from one another in the vertical direction for the first primary optics 2 and the first secondary optics 3. Furthermore, three first light sources 1 are also arranged spaced apart from one another in a vertical direction for the second primary optics 2 and the second secondary optics 3 (see FIG. 2). It is entirely possible to provide more or fewer than three first light sources 1 in each case. The first light sources 1 are designed as light-emitting diodes (LEDs).

The primary optics 2 are each designed as a collimating optics with three collimating lenses 12, wherein each of the collimating lenses 12 has an entry surface and an exit surface (see FIG. 1 and FIG. 2). The collimating lenses 12 are also arranged spaced apart from one another in the vertical direction. In this context, each of the first light sources 1 is assigned to one of the collimating lenses 12 in such a manner that the light emanating from one of the light sources 1 passes successively through the entry surface and the exit surface of the assigned collimating lens 12.

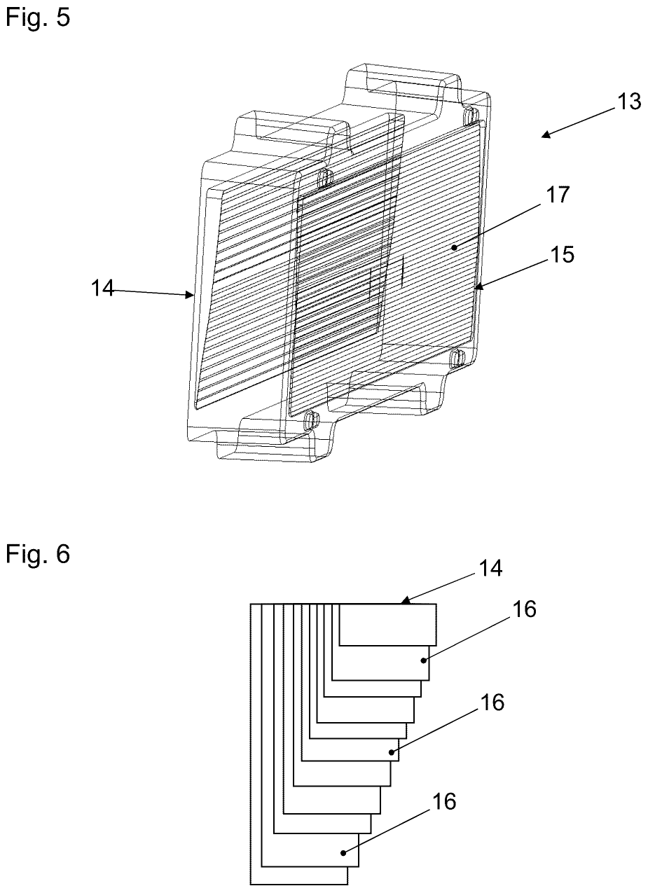

The secondary optics 3 each have a first portion, which is formed on a transparent substrate 13 with an entry surface 14 and an exit surface 15. A structure is provided on the entry surface 14 and on the exit surface 15 of the substrate 13. Here, the substrate 13 has at least one array of irregularly shaped cylindrical lenses, wherein the entry surface 14 of the substrate 13 has a plurality of input facets 16 of different sizes, and wherein the exit surface 15 of the substrate 13 has a plurality of output facets 17 of equal size (see FIG. 5 and FIG. 6). The structure is configured to shape light passing through the substrate 13 in the vertical direction when the lighting device is installed in the vehicle, in particular, to create a horizontal cut-off line and/or a gradual vertical light distribution.

To shape the light in the horizontal direction, the secondary optics 3 each have a second portion that is integrated into the decoupling optics 10. The second portion of the secondary optics 3 is formed on the exit surface 11 of the decoupling optics 10. The light emanating from the substrate 13 of the respective secondary optics 3 can enter an entry surface 18 of the decoupling optics 10 opposite the exit surface 11 and exit from the exit surface 11 of the decoupling optics 10.

On the exit surface 11 of the decoupling optics 10, outside the convex lenses 8 (see FIG. 2) or outside the lens 9 designed as a Fresnel lens (see FIG. 4), a strip-shaped structure is provided as the second portion of the secondary optics 3, which is formed by cylindrical lenses. Here, the cylindrical lenses are arranged side by side in the horizontal direction when the lighting device is installed in the vehicle, wherein the cylinder axes of the cylindrical lenses extend in the vertical direction when the lighting device is installed in the vehicle, in order to expand the light passing through the strip-shaped structure in the horizontal direction.

It is entirely possible that a strip-shaped structure serving as the second portion of the secondary optics 3 is additionally or alternatively provided on the entry surface 18 of the decoupling optics 10.

In the decoupling optics 10, the regions provided with the strip-shaped structure and the convex lens 8 or the lens 9 designed as a Fresnel lens are integrally connected to one another.

In the first exemplary embodiment shown in FIG. 1 and FIG. 2, the two transparent substrates 13 of the secondary optics 3 and the second convex lens 7 are integrally combined in a single component.

In the second exemplary embodiment shown in FIG. 3 and FIG. 4, the two transparent substrates 13 of the secondary optics 3 and the second convex lens 7 are designed as discrete components separate from one another.

In the second exemplary embodiment shown in FIG. 3 and FIG. 4, it is entirely possible to integrally combine the two transparent substrates 13 of the secondary optics 3 and the second convex lens 7 with one another in a single component.

Furthermore, in the first exemplary embodiment shown in FIG. 1 and FIG. 2, it is entirely possible to form the two transparent substrates 13 of the secondary optics 3 and the second convex lens 7 as discrete components separate from one another.

When installed in the vehicle, the second light source 4 is arranged horizontally between the first light sources 1. Furthermore, when installed in the vehicle, the projection optics 5 is arranged horizontally between the first and the second primary optics 2 and between the first and the second secondary optics 3.

### LIST OF REFERENCE NUMBERS

1 first light source
2 primary optics
3 secondary optics
4 second light source
5 projection optics
6 first convex lens of the projection optics
7 second convex lens of the projection optics
8 third convex lens of the projection optics
9 lenses of the projection optics designed as Fresnel lenses
10 decoupling optics
11 exit surface of the decoupling optics
12 collimating lens of the primary optics
13 transparent substrate of the secondary optics
14 entry surface of the transparent substrate
15 exit surface of the transparent substrate
16 input facet on the entry surface of the transparent substrate
17 output facet on the exit surface of the transparent substrate
18 entry surface of the decoupling optics

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, the lighting device comprising:
at least one first light source;
at least one primary optics;
at least one secondary optics, wherein the lighting device is configured such that the light emanating from the at least one first light source passes through the at least one primary optics and through the at least one secondary optics to generate at least one first portion of a main lighting function;
a second light source, which has a plurality of semiconductor elements, each having a light-emitting surface, wherein the light-emitting surfaces of the semiconductor elements are arranged in a matrix-like manner for the targeted generation of pixels of a light distribution of at least one second portion of a main lighting function;
a projection optics configured to project light emanating from the second light source into the exterior of the motor vehicle; and
a common exit surface for the light used to generate the at least one first portion of a main lighting function and for the light used to generate the at least one second portion of a main lighting function.

2. The lighting device according to claim 1, wherein the lighting device comprises a decoupling optics at which the common exit surface is formed for the light used to generate the at least one first portion of a main lighting function and for the light used to generate the at least one second portion of a main lighting function.

3. The lighting device according to claim 1, wherein the semiconductor elements of the second light source are designed as light-emitting diodes and are configured to be controlled independently of one another in order to generate pixels of a light distribution, wherein the second light source is designed as a solid-state LED array, wherein the solid-state LED array has 48 light-emitting diodes or more than 48 light-emitting diodes.

4. The lighting device according to claim 1, wherein the lighting device has a plurality of first light sources, and wherein the at least one primary optics is configured as collimating optics having a plurality of collimating lenses, each of which has an entry surface and an exit surface, through which the light emanating from the first light sources passes successively.

5. The lighting device according to claim 1, wherein the at least one secondary optics comprises a first portion which is formed on a transparent substrate having an entry surface and an exit surface, wherein a structure is provided on at least one of the entry surface and the exit surface of the substrate, which structure is configured to shape the light passing therethrough in the vertical direction when the lighting device is installed in the vehicle, and wherein the substrate is configured to generate at least one of a horizontal cut-off line and a gradual vertical light distribution.

6. The lighting device according to claim 5, wherein the transparent substrate of the at least one secondary optics has at least one array of irregularly shaped cylindrical lenses, wherein the entry surface of the substrate has a plurality of input facets of different sizes, and wherein the exit surface of the substrate has a plurality of output facets of equal size.

7. The lighting device according to claim 1, wherein the at least one secondary optics has a second portion, which is integrated into the decoupling optics, wherein the second portion of the at least one secondary optics is configured to expand the light passing therethrough in the horizontal direction when the lighting device is installed in the vehicle.

8. The lighting device according to claim 7, wherein the second portion of the at least one secondary optics is designed as a strip-shaped structure arranged on the exit surface of the decoupling optics, wherein the strip-shaped structure is formed by cylindrical lenses which are arranged next to one another in the horizontal direction when the lighting device is installed in the vehicle, and wherein the cylinder axes of the cylindrical lenses extend in the vertical direction when the lighting device is installed in the vehicle, in order to expand the light passing through the strip-shaped structure in the horizontal direction.

9. The lighting device according to claim 1, wherein the lighting device comprises at least two first light sources, two primary optics, and two secondary optics, wherein the lighting device is configured such that the light emanating from at least one of the first light sources passes through the first primary optics and through the first secondary optics, and such that the light emanating from at least one other of the first light sources passes through the second primary optics and through the second secondary optics.

10. The lighting device according to claim 9, wherein the strip-shaped structure of the second portion of the first secondary optics and the strip-shaped structure of the second portion of the second secondary optics are spaced apart from one another on the exit surface of the decoupling optics.

11. The lighting device according to claim 1, wherein the projection optics has a lens which is integrated into the decoupling optics.

12. The lighting device according to claim 11, wherein the lens of the projection optics integrated into the decoupling optics is arranged on the exit surface of the decoupling optics between the strip-shaped structure of the second portion of the first secondary optics and the strip-shaped structure of the second portion of the second secondary optics.

13. The lighting device according to claim 11, wherein the projection optics has at least one further lens serving as a projection lens, in addition to the lens integrated in the decoupling optics.

14. The lighting device according to claim 1, wherein the first portion of a main lighting function generated by the at least one first light source, the at least one primary optics, and the at least one secondary optics is at least a portion of at least one of a low beam and a high beam.

15. The lighting device according to claim 1, wherein the second portion of a main lighting function generated by the second light source and the projection optics is at least a portion of at least one of a low beam and a high beam.
